(19) United States
(12) Patent Application Publication
(10) Pub. No.: US 2010/0096227 A1
(43) Pub. Date: Apr. 22, 2010

(54) DAMPER

(76) Inventor: Mark Manuel, Conway, SC (US)

Correspondence Address: CARLSON, GASKEY & OLDS, P.C., 400 WEST MAPLE ROAD, SUITE 350, BIRMINGHAM, MI, 48009, US

(21) Appl. No.: 12/255,611

(22) Filed: Oct. 21, 2008

(51) Int. Cl. F16F 9/06

(52) U.S. Cl. 188/269

(57) ABSTRACT

An example damper assembly includes a tube, a piston assembly axially moveable relative to the tube between an extended position and a retracted position, and a material encapsulating a first fluid. The piston assembly is configured to compress the first fluid using a second fluid.

### BACKGROUND

This invention relates generally to a damper, and more particularly, to a noncavitating damper having a material separating a compressible fluid from another fluid.

As known, dampers dampen movements of components moveable relative to each other. In one example, a damper dampens movement of a component, such as a suspension component, on a zero turn radius lawn mower. Some dampers include a rod extending from a tube. One rod end is coupled to a first component, and an opposite rod end is coupled to a piston structure within the tube. The tube mounts to a second component. The rod is axially moveable relative to the tube between a fully extended position and a fully retracted position.

The piston structure moves against oil in the tube as the rod moves to a retracted position. A metering device controls movement of oil within the tube to control the damping rate of the damper. Some dampers include an air pocket, within the oil, that compresses to accommodate movement of the rod further within the tube. As known, such air pockets can undesireably cause irregular damping motions or cavitation, particularly when the air pocket moves through the metering device. Some noncavitating dampers have been developed that include a floating member axially separating the oil from the air pocket. As known, such noncavitating dampers are longer than other dampers because the noncavitating dampers must provide axial space for the floating member and the air pocket, in addition to the rod and the piston structure. These longer, noncavitating dampers are often difficult to package, especially within confined areas.

### SUMMARY

An example damper assembly includes a tube, a piston assembly axially moveable relative to the tube between an extended position and a retracted position, and a material encapsulating a first fluid. The piston assembly is configured to compress the first fluid using a second fluid.

A example method for controlling movement of a damper assembly includes encapsulating a first fluid within a material, moving a piston assembly to displace a second fluid, and compressing the first fluid using the displaced second fluid.

These and other features of the example disclosure can be best understood from the following specification and drawings, the following of which is a brief description:

### BRIEF DESCRIPTION OF THE DRAWINGS

FIG. 1 shows a cross-sectional view of an example damper assembly in an extended position.

FIG. 1A shows a close-up view of a portion of the FIG. 1 damper.

FIG. 2 shows a cross-sectional view of the FIG. 1 damper assembly in a retracted position.

FIG. 2A shows a close-up view of a portion of the FIG. 2 damper.

FIG. 3 shows a side view of the FIG. 1 damper assembly.

FIG. 4 shows a metering device for the example damper assembly.

FIG. 5 shows another example damper assembly configured to move to a repeatable return position.

FIG. 6 shows yet another example damper assembly configured to move to a repeatable return position.

### DETAILED DESCRIPTION

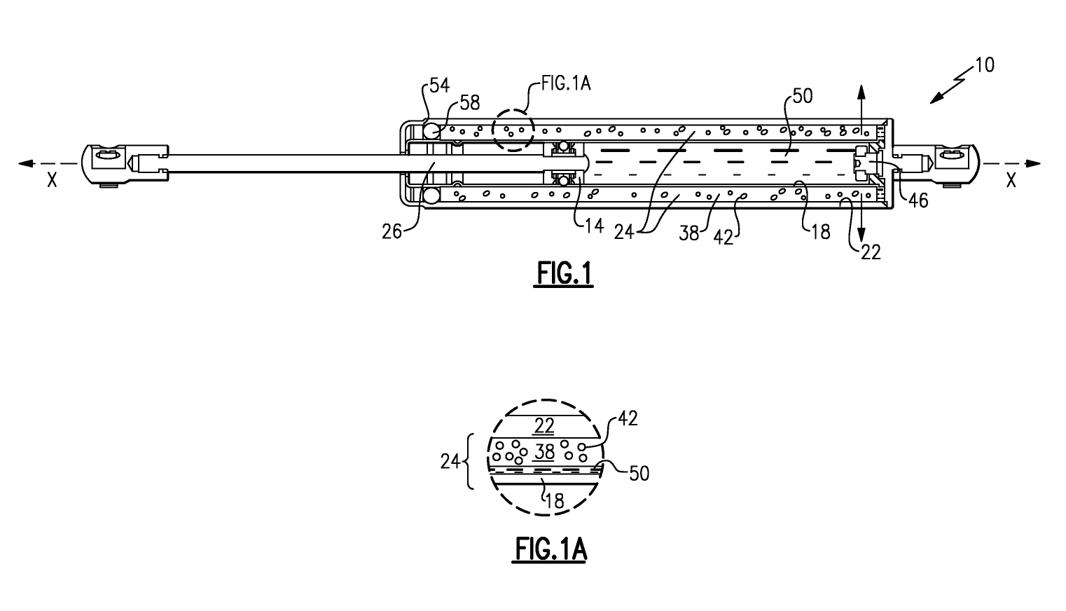

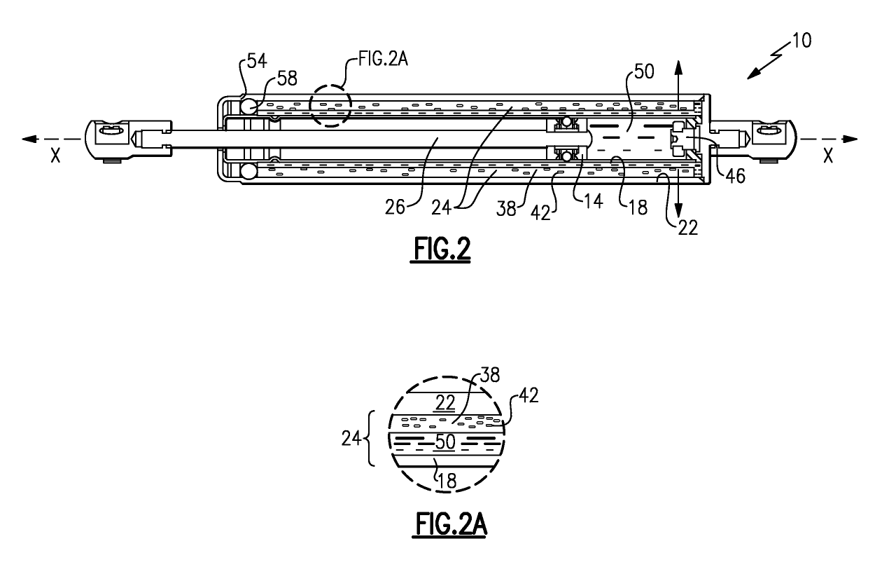

Referring to FIGS. 1-3, an example damper assembly 10 includes a piston structure 14 within a damper tube 18. A housing 22 surrounds the damper tube 18 to define an annular space 24 between the damper tube 18 and the housing 22. A rod 26 extends from the piston structure 14 and is pivotably coupled to first component 30 at 32. The rod 26 and the piston structure 14 together form a piston assembly in this example.

The damper tube 18 is pivotably coupled to a second component 34 at 36. In this example, the first component 30 and the second component 34 are vehicle components, such as steering components for a zero-turn radius lawn mower. As known, moving the rod 26 along an axis x between extended positions and retracted positions facilitates damped relative movements between the first component 30 and the second component 34.

In this example, the annular space 24 within the damper assembly 10 accommodates a material 38 encapsulating a first fluid 42, which is air in this example. The damper assembly 10 also includes a second fluid 50 that is moveable between the annular space 24 and the damper tube. The second fluid 50, which is oil in this example, is substantially noncompressible. Accordingly, the piston structure 14 displaces, rather than compresses, the second fluid 50 as the rod 26 moves to the retracted position.

The displaced second fluid 50 flows through a metering device 46 to the annular space 24 and exerts force on the material 38. These forces increase as the piston structure 14 forces more of the second fluid 50 into the annular space 24 against the material 38. Sufficient force on the material 38 compresses the first fluid 42 within the material 38 in a radial direction relative to the axis x. Compressing the first fluid 42 creates space within the annular space 24 for accommodating more of the second fluid 50 flowing through the metering device 46.

Moving the rod 26 in the opposite direction (from retracted positions to extended positions) relieves pressure on the material 38 as the second fluid 50 flows back through the metering device 46 to the damper tube 18. The first fluid 42 expands within the material 38 to fill the area within the annular space 24 vacated by the second fluid 50. As the material 38 encapsulates the first fluid 42 in this example, only the second fluid 50 flows through the metering device 46. In one example, the first fluid 42, expanding within the material 38, helps urge the second fluid 50 to the damper tube 18.

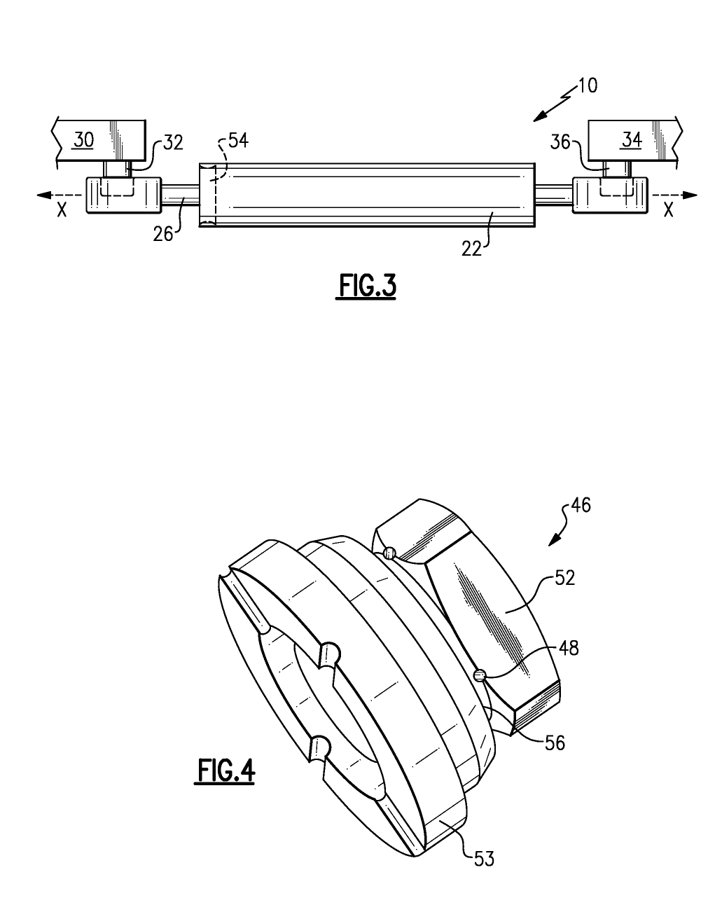

Referring to FIG. 4 with continuing reference to FIGS. 1-3, the metering device 46 defines a plurality of apertures 48 that communicate flow of the second fluid 50 between the damper tube 18 and the annular space 24 when the rod 26 moves to retracted positions. When the rod 26 and piston structure 14 move to extended positions, the flow direction of the second fluid 50 though the metering device 46 is reversed. Flow in this direction moves a first member 52 of the metering device 46 relative to a second member 53, which opens a plurality of additional flow paths 56 within the metering device 46. When open, the additional flow paths 56 permit more flow through the metering device 46 than the apertures 48 alone. Accordingly, the flow rate through the metering device 46 from the annular space 24 to the damper tube 18 is greater than the flow rate through the metering device 46 from the damper tube 18 to the annular space 24. As known, controlling flow facilitates controlling movement characteristics (e.g., speed, smoothness, etc.) of the damper assembly 10.

In this example, the material 38 is a CPE-EPDM foam material having a density of about 30 lb/ft³ (480 kg/m³). In some examples, the material 38 helps control movement characteristics (e.g., speed, smoothness, etc.) of the damper assembly 10. For example, the denser the material 38, the faster the rod 26 moves to the extended position. Also, in some examples, the material 38 does not encapsulate the first fluid 42, but instead separates the first fluid 42 from the second fluid 50.

Although the material 38 is described as foam in this example, those skilled in the art and having the benefit of this disclosure will understand that other materials are suitable for separating the first fluid 42 from the second fluid 50, and further that arrangements (other than positioning the material 38 within the annular space 24) are possible and fall within the scope of the disclosed embodiment.

In this example, the material 38 has an “o”-shaped cross-section and holds the radial position of the damper tube 18 within the housing 22. That is, radial movements of the damper tube 18 within the housing 22 in direction Y are limited by the damper tube 18 contacting the material 38. A crimped portion 54 of the housing 22 also limits relative movements between the damper tube 18 and the housing 22. A seal 58 near the crimped portion 54 limits movement of the second fluid 50 from the annular space 24. Arranging the damper tube 18 in this manner facilitates accommodating misalignments between the housing 22, the damper tube 18, and other components of the damper assembly 10.

In this disclosure, like reference numerals designate like elements where appropriate, and reference numerals with the addition of one-hundred or multiples thereof designate modified elements. The modified elements incorporate the same features and benefits of the corresponding modified elements, expect where stated otherwise.

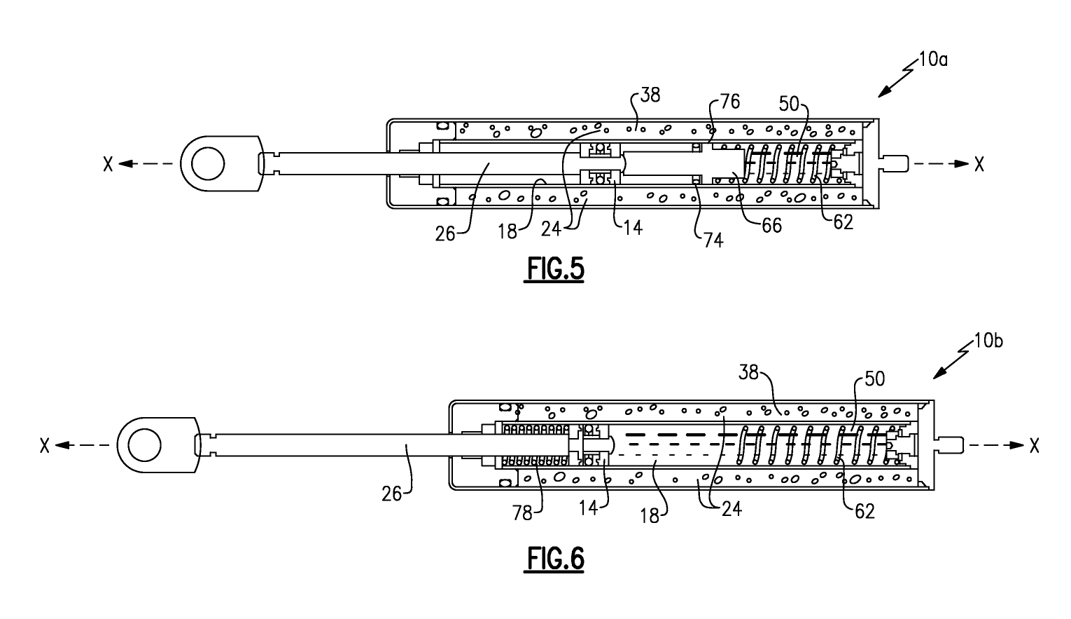

Referring now to FIG. 5, in another example, a damper assembly 10a includes a spring 62 that biases a spacer 66 toward the piston structure 14. In this example, the spring 62 and the spacer 66 moves the piston structure 14 toward a return position that is relatively axially centered within the damper tube 18. Other examples include other return positions. A radially extending flange 70 on the spacer 66 contacts a feature 74 on the interior of the damper tube 18 to limit axially movement of the spacer 66 toward the piston structure 14. The arrangement of the damper assembly 10a facilitates extending the rod 26 to a repeatable return position where the spacer 66 contacts the feature 74 and the piston structure 14. In this example, the piston structure 14 and the spacer 66 are not connected, thus the piston structure 14 is moveable along the axis X away from the spacer 66.

The feature 74, in this example, is a bump extending radially inward past a radially outer edge 76 of the flange 70 on the spacer 66. The feature 74 prevents further movement of the spacer 66 along axis X away from the spring 62. Crimping, knurling, and other manufacturing processes are used to form the feature 74 in this example.

Referring to FIG. 6, another example damper assembly 10b includes the spring 62, but uses a second spring 78 in place of the spacer 66 and feature 74. The springs 62, 78 bias the piston structure 14 toward the return position within the damper tube 18. In this example, the spring 78 is shown in a more biased position than the spring 62, and the piston structure 14 is not shown in the return position. In this example, moving the piston structure 14 away from the spring 62 requires overcoming the biasing force of the spring 78.

Features of these examples include a noncavitating damper having a shorter overall length than previous designs while incorporating two fluids separated by a material. Another feature includes limiting relative movement of the damper tube utilizing the material separating the fluids. A feature of the examples that move to a repeatable return position is returning a piston assembly to a repeatable position to return a throttle to a neutral position in a zero turn radius lawnmower.

Although a preferred embodiment has been disclosed, a worker of ordinary skill in this art would recognize that certain modifications would come within the scope of this invention. For that reason, the following claims should be studied to determine the true scope and content of this invention.

We claim:

1. A damper assembly, comprising:
a tube;
a piston assembly axially moveable relative to the tube between an extended position and a retracted position; and
a material encapsulating a first fluid, wherein the piston assembly is configured to compress the first fluid using a second fluid.

2. The damper assembly of claim 1, wherein the piston is configured to compress the first fluid as the piston assembly moves from the extended position to the retracted position and to allow expansion of the first fluid as the piston assembly moves from the retracted position to the extended position.

3. The damper assembly of claim 1, including a housing that receives the tube to define an annular space radially between the housing and the tube, the material received within the annular space.

4. The damper assembly of claim 3, wherein the second fluid is positioned between the material and at least one of the housing and the tube when the piston assembly is in the retracted position.

5. The damper assembly of claim 3, wherein the material holds the tube within the housing.

6. The damper assembly of claim 1, wherein the material is outside of the tube.

7. The damper assembly of claim 1, wherein the second fluid radially compresses the first fluid radially relative to the piston assembly.

8. The damper assembly of claim 1, wherein the tube defines an axis and the piston assembly is axially movable along the axis between the extended position and the retracted position.

9. The damper assembly of claim 1, including a metering device that controls flow of the second fluid, wherein the metering device permits less flow when the piston assembly moves from the extended position to the retracted position than when the piston assembly moves from the retracted position to the extended position.

10. The damper assembly of claim 1, wherein the material comprises foam.

11. The damper assembly of claim 1, wherein the first fluid comprises air.

12. The damper assembly of claim 1, wherein the second fluid comprises oil.

13. A method for controlling movement of a damper assembly, comprising:
encapsulating a first fluid within a material;
moving a piston assembly to displace a second fluid; and
compressing the first fluid using the displaced second fluid.

14. The method of claim 13, wherein the material comprises foam.

15. The method of claim 13, including compressing the first fluid radially relative to the direction of piston assembly travel.

16. The method of claim 13, including a feature adapted to position the piston assembly in a repeatable position.

17. A damper assembly comprising:
a tube;
a piston assembly axially moveable relative to the tube between an extended position and a retracted position;
a housing surrounding the tube; and
a material positioned radially between the tube and the housing, the material separating a first fluid from a second fluid, wherein the piston assembly is operative to compress the first fluid using the second fluid when the piston assembly is in the retracted position.

18. The damper assembly of claim 17, wherein the first fluid radially compresses the compressible material.

19. The damper assembly of claim 17, wherein the compressible material holds at least a portion of the tube.

20. The damper assembly of claim 17, including a metering device controlling flow of the first fluid to and from the tube.

21. The damper assembly of claim 17, including a spring that biases the piston assembly toward return position.

22. The damper assembly of claim 17, including a feature extending from the tube that limits movement of the piston assembly toward the extended position.

23. The damper assembly of claim 21, including a spacer positioned between the spring and the piston assembly.

24. The damper assembly of claim 21, including a second spring that biases the piston assembly toward a return position.
